(19) United States
(12) Patent Application Publication
(10) Pub. No.: US 2004/0077224 A1
(43) Pub. Date: Apr. 22, 2004

(54) Combination terminal device

(76) Inventor: Greg M. Marchese, Stamford, CT (US)

Correspondence Address: OSTRAGER CHONG & FLAHERTY LLP, 825 THIRD AVE, 30TH FLOOR, NEW YORK, NY, 10022-7519, US

(21) Appl. No.: 10/436,762

(22) Filed: May 13, 2003

Related U.S. Application Data
(60) Provisional application No. 60/379,932, filed on May 13, 2002.

(51) Int. Cl. H01R 13/502

(52) U.S. Cl. 439/696

(57) ABSTRACT

A terminal block for a stage pin connector having an interior end that will admit of both a Direct Wire termination method and a Lugged Wire termination method.

### CROSS REFERENCE TO RELATED APPLICATIONS

This application claims the benefit of U.S. Provisional Patent Application No. 60/379,932 filed May 13, 2003, which is incorporated herein by reference.

### FIELD OF INVENTION

This invention generally relates to a new termination style for a stage-pin connector, and more particularly, to a termination device that combines two existing modes of connector termination into one connector.

### BACKGROUND OF INVENTION

Stage-pin connectors offer secure and easy electrical connections for a variety of applications in the entertainment lighting industry, and are among the most widely used products in the film and television industries. Referring to FIG. 1, typical connectors comprise a male body portion 10 having a plurality of pins 12 extending from a front edge 14 and a female body portion (not shown) of similar configuration but having a plurality of sockets in one edge that accept the pins 12 extending from the male body portion 10 to make an electrical connection. The pins and sockets are made from an electrically conductive material, such as brass, and have interior ends 16 that extend into the body portions for connection to electrical wires. The interior ends 16 are commonly referred to as terminal blocks and have a means for connection to an electrical wire or cable.

There are many methods known in the prior art for making the electrical connection between the terminal block and the electrical wires. Two of the more common modes of termination are known as the “Direct Wire” or “Wire Shoe” method (FIG. 1), and the “Lugged” or “Crimp” method (FIG. 2).

Referring to FIG. 1, the terminal block 16 used in a Direct Wire connection has a first bore or hole 18 extending from its interior vertical surface 20 into the terminal block 16, and a second bore or hole 22 extending from its top surface 24 into the terminal block 16, such that the first and second bores intersect. The second bore or hole 22 is threaded on its interior surface to accept and firmly secure a set screw 26. In the Direct Wire method, the electrical wires 28 first have their outer jackets stripped down to the proper length leaving bare wire exposed at the end. The bare wire is then covered with a copper ferrule 30 and firmly inserted into the first bore 18 in the terminal block in the direction shown by the arrow A. The set screw 26 is then placed into the threaded hole 22 in the top of the terminal block and tightened down with a screwdriver until the head of the screw is flush with the terminal block's top surface 24 and the copper ferrule 30 has been crushed (crimped) into place.

The terminal block 32 used in a Lugged Wire connection (FIG. 2) has a first horizontal surface 34 at its end, which is recessed below a second horizontal surface 36 to form a notched terminal block end. The first recessed surface 34 has an aperture or hole 38 extending from the recessed surface 34 into the terminal block 32. The aperture is threaded on its interior surface to accept and firmly secure a set screw 34. In the Lugged Wire method, the outer jackets of each wire 42 are stripped down to the proper length leaving bare wire exposed. A lug 44 having a circular connector 46 extending from its open end is then placed over the exposed wire and crimped with a crimping tool. The lug's circular connector 46 is then placed over the terminal block's screw hole 38 and a locking washer 48 is placed over the circular connector 46. The terminal set screw 40 is then positioned through the lug 44 and washer 46 and tightened down with a screwdriver until tightly sealed.

Each of these termination methods may be used in a variety of applications, and some of the applications can use either method. However, it is often desirable to be able to choose at a job site which termination method would be best to use. This necessarily requires that a technician have available pin connectors with both types of termination methods because the terminal blocks used for each termination method do not accept wires prepared for the other termination method.

Therefore, it is a broad object of this invention to provide a connector comprising a terminal block that can be used with both Direct Wire and Lugged Wire termination methods such that a user can chose on the fly which termination method is best for a particular application. Such a connector will provide efficiencies to both manufacturers as well as to customers. The manufacturing benefits include: (i) eliminating an entire product by not needing to stock two different styles of connector has an immediate impact on warehouse space; (ii) stocking only one type of connector also has a significant impact on cash flow; (iii) the marketing impact is also not inconsequential—we will be able to market and sell to new markets and new customers by means of innovation and added value. The benefits and impact on customers include: (i) customers no longer need to stock two styles of connector; (ii) customers can choose on the fly, which termination method is right for each individual application; (iii) the need for forecasting which type of connector will sell more and which will sell poorly is eliminated, freeing up warehouse space and cash flow for the customer.

### SUMMARY OF INVENTION

In the present invention, these objects, as well as others, are achieved by providing a terminal block for use with either pins or sockets in a stage pin connector that will admit of both a Direct Wire and a Lugged Wire connection method.

To accommodate both types of terminal styles in one connector, the interior (or terminal) end of a brass terminal block is modified to accept both a Direct Wire connection and a Lugged connection with out modifying the size or dimensions of the stage pin connector. In a preferred embodiment, the terminal end of the terminal block has both a recessed or notched end portion having a hole in its upper horizontal surface (to accept a Lugged Wire connection) and a bore or hole extending from the terminal end's vertical surface into the terminal block (to accept a Direct Wire connection). The height of the terminal end's vertical surface was sized to accommodate the height of the screw head required by the Lugged Wire connection and the width of the ferrule required by the Direct Wire connection. Recesses were also formed in the interior surface of the cover of the stage pin connector to provide additional clearance inside the connector for the screw head used for a Lugged Wire connection.

Other objects, features and advantages of the present invention will be apparent when the detailed description of the preferred embodiments of the invention are considered in conjunction with the drawings which should be construed in a illustrative and not limiting sense as follows.

### BRIEF DESCRIPTION OF DRAWINGS

FIG. 1 is a perspective view of a typical stage pin connector having three pins with terminal blocks that utilize the Direct Wire connection method.

FIG. 2 is a perspective view of a typical stage pin connector having three pins with terminal blocks that utilize the Lugged Wire connection method.

FIG. 3 is a perspective view of a pin for use in a male stage pin connector that will admit of both a Direct Wire and Lugged Wire connection in accordance with a preferred embodiment of the invention.

FIG. 4 is an exploded perspective view of a stage pin connector having three of the pins shown in FIG. 3 and wires connected with the Direct Wire connection method.

FIG. 5 is a cross-sectional view of the stage pin connector taken along the line 5-5 of FIG. 4.

FIG. 6 is a perspective view of a socket for use in a female stage pin connector that will admit of both a Direct Wire and Lugged Wire connection in accordance with a preferred embodiment of the invention.

FIG. 7 is an exploded perspective view of a stage pin connector having three of the sockets shown in FIG. 6 and wires connected with the Lugged Wire connection method.

FIG. 8 is a cross-sectional view of the stage pin connector taken along the line 8-8 of FIG. 7.

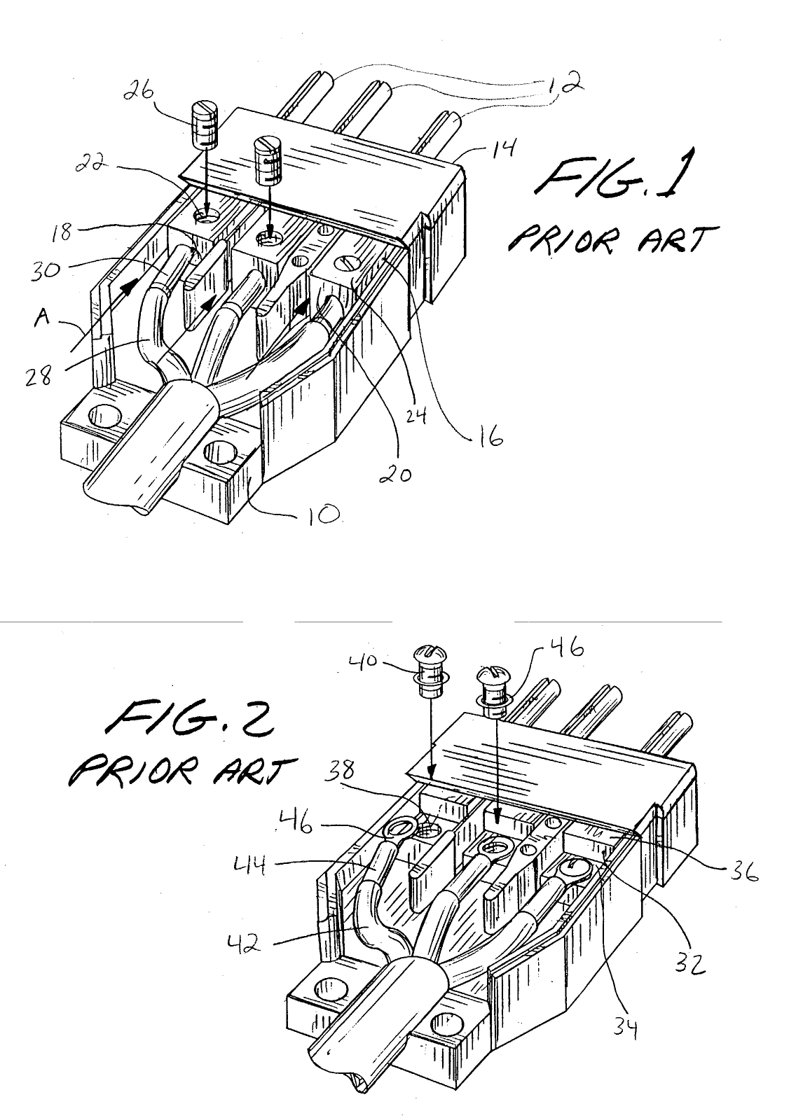

### DESCRIPTION OF A PREFERRED EMBODIMENT

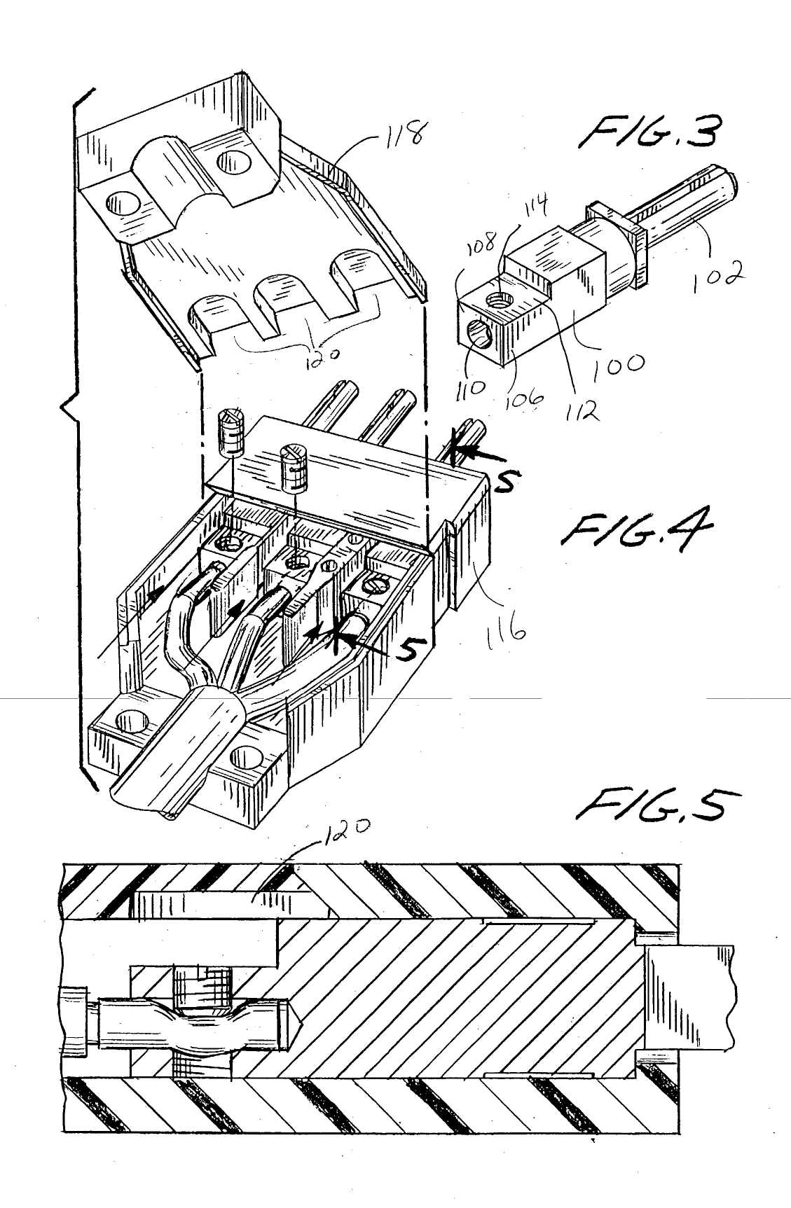

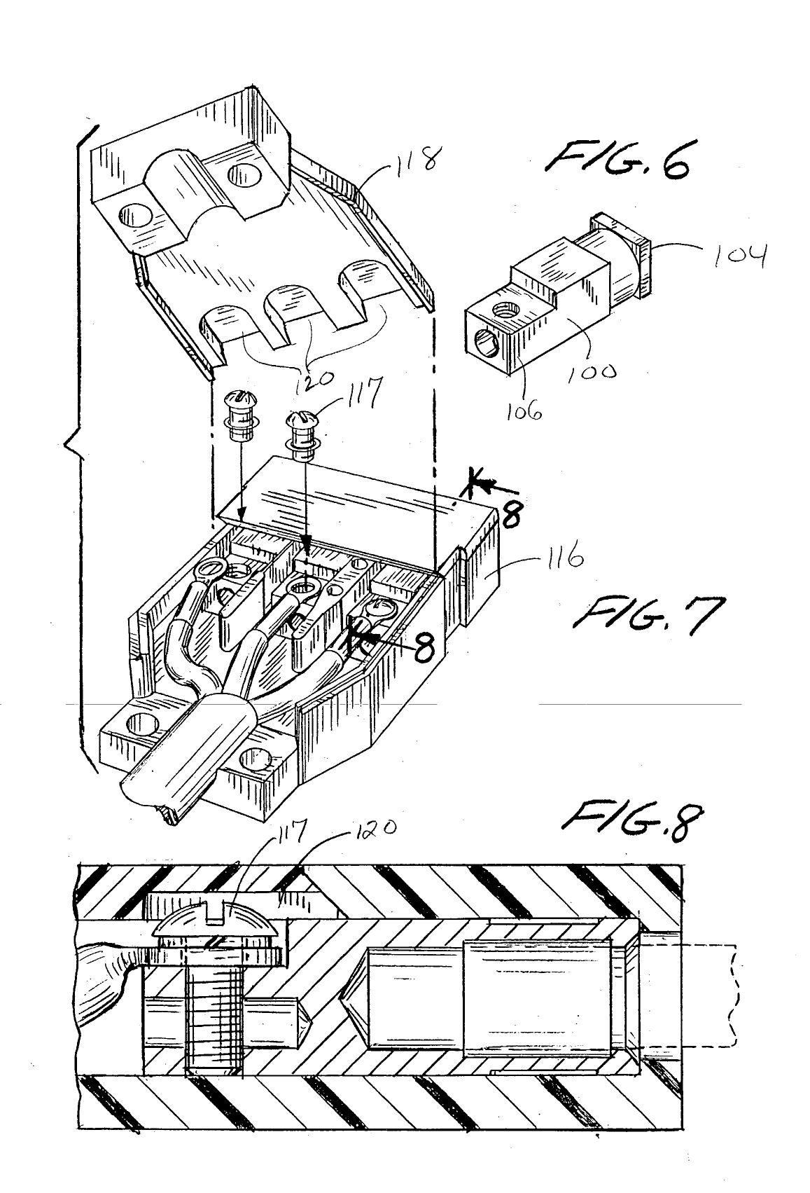

A preferred terminal block 100 in accordance with the teachings of this invention that may be used with either a pin 102 or a socket 104 in any available male or female stage pin connector is shown in FIGS. 3 and 6. The terminal block has an interior end 106 comprising a vertical end surface 108 having a first hole 110 extending from the vertical end surface into the terminal block, and a notched horizontal surface 112 having a second hole 114 extending from the notched horizontal surface into the terminal block such that the first and second holes intersect within the terminal block. The second hole 114 is threaded on its interior surface to accept and firmly secure a set screw therein.

Referring to FIGS. 4 and 7, the terminal block 100 is placed in a stage pin connector 116 to form either a male (FIG. 4) or female (FIG. 7) connector. As shown in these drawings, the terminal block can accept both a conventional Direct Wire connection (FIG. 4) and a Lugged Wire connection (FIG. 7), depending on a user's choice. No other modifications or equipment are necessary in the field to effectuate either connection.

The previous Direct Wire or Lugged Wire connection methods could not be combined into a single terminal block because there was not enough space inside the stage pin connector to accommodate all the necessary parts. To overcome this problem, the dimensions of the terminal block were efficiently proportioned permit use of either connection method.

In the preferred embodiment, the vertical end surface 108 of the terminal block 100 was modified to be high enough to accommodate the size of a typical copper ferrule used to cover the exposed wire in the Direct Wire method, but not too high to cause the screw head 117 required by the Lugged Wire method to prevent closure of the stage pin connector's removable access cover 118. To ensure that the access cover 118 can be securely closed, even when using the Lugged Wire connection method, the access cover has been provided with recessed or slotted areas 120 positioned over each of the terminal blocks in the stage pin connector.

Although the invention has been described and shown with reference to a preferred embodiment, it will be appreciated by one of ordinary skill in the art that numerous modifications are possible in light of the above disclosure. For example, the size and placement of bores in the terminal block, as well as the screw thread and type of screw, may be modified to meet any type of wiring application. Further, the dimensions and shape of the stage pin connector may be modified insofar as the terminal block disclosed in this invention is intended for use with any type of stage pin connector. All such variations and modifications are intended to be within the scope and spirit of this invention.

I claim:

1. A terminal block for use in an electrical connector comprising a vertical end surface having a first bore extending from the vertical end surface into the terminal block and a notched horizontal surface having a second bore extending from the horizontal surface into the terminal block such that the first bore and second bore intersect within the terminal block.

2. A terminal block as in claim 1, wherein the first bore is of sufficient size to accept a wire covered with a ferrule and the vertical end surface has a height substantially equal to the size of the first bore.

3. A terminal block as in claim 1, wherein the first bore is positioned substantially adjacent to the notched horizontal surface and a bottom surface of the terminal block.

4. An electrical connector comprising a plurality of pins each having an interior terminal end portion comprising a vertical end surface having a first bore extending from the vertical end surface into the terminal end portion and a notched horizontal surface having a second bore extending from the horizontal surface into the terminal end portion such that the first bore and the second bore intersect within the terminal end portion.

5. An electrical connector as in claim 4, wherein the first bore is of sufficient size to accept a wire covered with a ferrule and the vertical end surface has a height substantially equal to the size of the first bore.

6. An electrical connector as in claim 4, wherein the first bore is positioned substantially adjacent to the notched horizontal surface and a bottom surface of the terminal end portion.

7. An electrical connector as in claim 4, further comprising a removable cover having an interior surface comprising a plurality of slots, each of the slots being positioned over the interior terminal end portion of each of the plurality of pins when the removable cover is positioned on the connector.

8. An electrical connector comprising a plurality of sockets each having an interior terminal end portion comprising a vertical end surface having a first bore extending from the vertical end surface into the terminal end portion and a notched horizontal surface having a second bore extending from the horizontal surface into the terminal end portion such that the first bore and the second bore intersect within the terminal end portion.

9. An electrical connector as in claim 8, wherein the first bore is of sufficient size to accept a wire covered with a ferrule and the vertical end surface has a height substantially equal to the size of the first bore.

10. An electrical connector as in claim 8, wherein the first bore is positioned substantially adjacent to the notched horizontal surface and a bottom surface of the terminal end portion.

11. An electrical connector as in claim 8, further comprising a removable cover having an interior surface comprising a plurality of slots, each of the slots being positioned over the interior terminal end portion of each of the plurality of sockets when the removable cover is positioned on the connector.
